(19) United States
(12) Patent Application Publication
(10) Pub. No.: US 2009/0006455 A1
(43) Pub. Date: Jan. 1, 2009

(54) Automated time metadata deduction

(75) Inventor: Matthew Carroll, Seattle, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 11/824,719

(22) Filed: Jun. 30, 2007

(51) Int. Cl. G06F 17/00

(52) U.S. Cl. 707/102; 707/103 R; 707/E17.005

(57) ABSTRACT

An arrangement for deducing descriptive metadata from data contained in a column of a relational table and associated existing metadata (e.g., that which identifies column data type and/or column name) is provided by a metadata deduction engine in a set of OLAP tools which operates in conjunction with an analysis services server. The metadata deduction engine applies one or more criteria that are configured to evaluate column data in order to deduce metadata that provides additional contextual meaning to the column data beyond that given by the existing metadata. The metadata deduction engine maps the column data to a metadata tag that is passed to the analysis services server to enable it to create an OLAP cube using the deduced metadata.

### BACKGROUND

Online analytical processing (“OLAP”) is often used to help business decision makers analyze their data to reveal trends that might not be discovered when viewing data in standard reports. While OLAP can be used in a large number of areas, OLAP tools are commonly used to perform trend analysis on sales and financial information by summarizing information into multidimensional views and hierarchies. For example, OLAP classically provides views of the volume of sales by region, time, and product. OLAP lets users drill down from higher levels like regional analyses down to store level analyses, roll up from lower levels like sales by week to sales by month, and focus on certain data such as that associated with a particular product or line.

An abstract representation of data called an OLAP cube is commonly used. An OLAP cube typically has many dimensions because a query applied to the cube returns data that comes from multiple tables in an underlying database. OLAP cubes can particularly benefit by having a time dimension and the time attributes it contains correctly identified. This additional identification metadata allows the OLAP system to perform time based calculations such as year-to-date and semi-additive aggregation of values, helps in automatic construction of navigation hierarchies, and may be useful metadata to present to end users, among other benefits.

Currently, when an OLAP dimension is built based on the contents of a table from the database, the administrator creating the dimension must manually identify tables that contain primarily time data and then identify each column containing time related data with the type of the time data it contains. This process requires the user to be familiar with the data and can be time consuming and prone to mistakes.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An arrangement for deducing descriptive metadata from data contained in a column of a relational table and associated existing metadata (e.g., that which identifies column data type and/or column name) is provided by a metadata deduction engine in a set of OLAP tools which operates in conjunction with an analysis services server. The metadata deduction engine applies one or more criteria that are configured to evaluate column data in order to deduce metadata that provides additional contextual meaning to the column data beyond that given by the existing metadata. The metadata deduction engine maps the column data to a metadata tag that is passed to the analysis services server to enable it to create an OLAP cube using the deduced metadata.

In an illustrative example, the criteria include those which filter column data and/or existing metadata, and those which generate a score that represents the likelihood that a column may be represented by a particular metadata tag. The criteria respectively evaluate column data type, a distinct count of objects in the column, data values of the objects, column name, and the relationship of distinct counts among columns. Various types of logic may be used when applying the criteria to the columns to enable the deduction to be robust and accurate.

The present arrangement enables more detailed and specific metadata to be deduced about the data contained in the column than is currently given in a relational table. So while a relational database may provide existing metadata to indicate that a column contains a DateTime value and is named “Date,” the metadata deduction engine can further determine that the column contains data values that consist solely of dates (that is, the time of day portion of the data in the column is irrelevant). For another column, the relational table may provide existing metadata that indicates that the column contains String values and is named “MOY”, whereas the metadata deduction engine can further deduce that the values are names representing the 12 months of the year.

A metadata tag is presented as a suggestion, through an application programming interface (“API”) that supports a graphical user interface (“GUI”), to a user such as an administrator that is designing or deploying an OLAP cube to confirm that the deduced metadata accurately describes the nature of the data. When so confirmed, the metadata tag is provided to the analysis services server in order to create the OLAP cube.

Advantageously, utilization of the present arrangement for automated metadata deduction can save time when designing, deploying, and maintaining OLAP cubes in a business intelligence environment while reducing the errors that are inherent with manual processes.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative business intelligence environment in which analysis services including OLAP are provided to a group of clients;

FIGS. 2a and 2b depict a group of illustrative tables that show views of data in a database;

FIG. 3 shows an illustrative OLAP cube that reflects data from the tables shown in FIG. 2;

FIG. 4 shows the relationship between objects in an OLAP cube;

FIG. 5 shows details of an illustrative metadata deduction engine; and

FIG. 6 shows an illustrative set of criteria that may be applied to deduce metadata.

Similar reference numerals indicate similar elements in the drawings.

### DETAILED DESCRIPTION

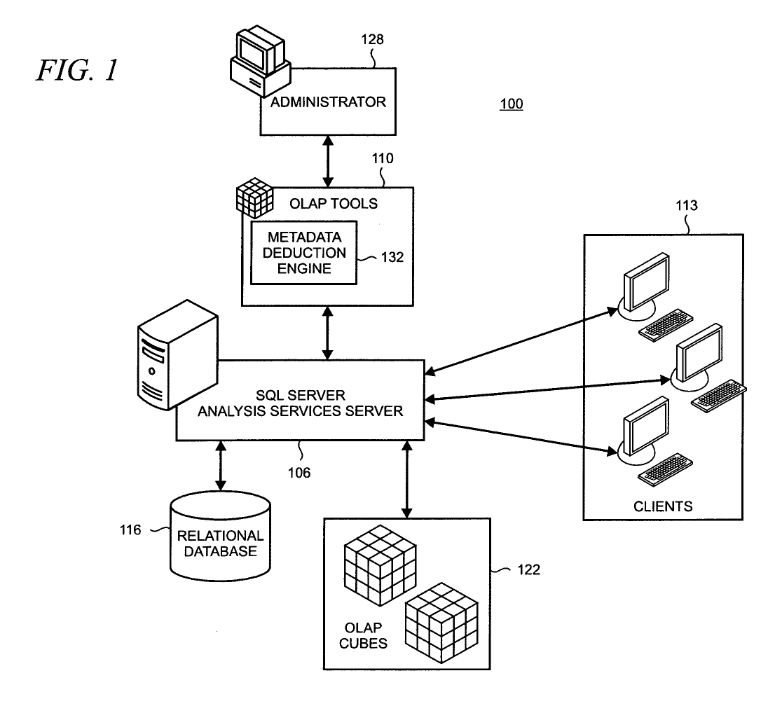

FIG. 1 shows an illustrative business intelligence environment 100 in which an analysis services server 106 operates with OLAP tools 110 in support of the provision of business intelligence and analysis services to a group of clients 113. Business intelligence (“BI”) is a broad category of application programs and technologies for gathering, storing, analyzing, and providing access to data to help users make better business decisions. BI applications commonly relate to the activities of decision support, query and reporting, OLAP, statistical analysis, forecasting, and data mining.

In this example, the analysis services server 106 is supported through a database product, Microsoft SQL Server™, which is used to implement a relational database management system (“RDBMS”) that employs a relational database 116 in the environment 100. An RDBMS is often used by enterprises such as businesses to store data, and the relationship among the data, in the form of tables. A structured query language (“SQL”) is used to retrieve and manage the data in the relational database 116. It is emphasized that SQL Server is representative of RDBMS systems which are widely deployed, and thus other such systems may be alternatively utilized.

The analysis services server 106 is generally arranged to implement business intelligence and online data analysis tools that are available to the clients 113 on their desktop PCs (personal computers), and which may interact with their locally running productivity applications such as spreadsheets. More specifically, analysis services server 106 is arranged here to provide OLAP capabilities where the clients 113 can access one or more OLAP cubes 122 in order to access aggregated and organized data that is sourced from the relational database 116. The OLAP cubes 122 are typically designed, deployed, and maintained in the environment 100 by an administrator 128 through interactions with the OLAP tools 110.

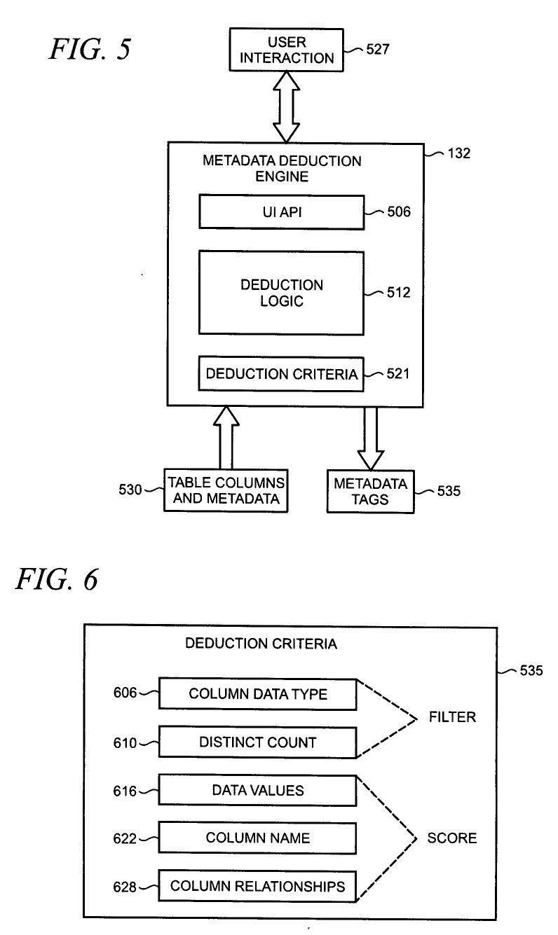

The OLAP tools 110 are further configured to include a metadata deduction engine 132. The metadata deduction engine 132 is arranged to automate certain aspects of OLAP cube generation through deduction of metadata that may be used to describe column data to thereby enable more automated generation of OLAP cubes, as described in more detail in the text accompanying FIG. 5 below. While the metadata deduction engine 132 is shown in this illustrative example as a component of OLAP tools 110, it is emphasized that the metadata deduction engine 132 may be alternatively implemented, for example, with standalone functionality, or otherwise be incorporated into other components in the environment 100 such as the analysis services server 106.

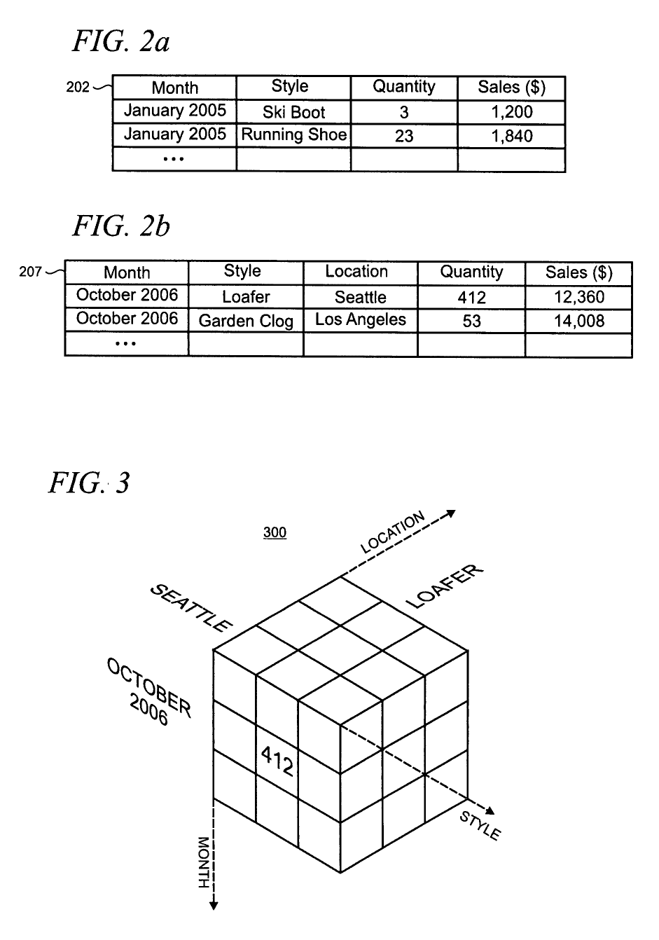

The discussion that accompanies the next several figures (FIGS. 2-4) is intended to provide some additional context for OLAP and define key terms. FIGS. 2a and 2b depict a group of simple illustrative tables that show views of some example data from a data source. As used here, a data source provides a logical data model for data in the relational database 116 including a series of related tables as well as metadata which typically includes the following: table names, column names, data types, primary key, foreign key relationships, annotations, and other common types of information.

Sales tables 202 and 207 are made up of columns which contain data regarding a fictitious company's sale of footwear by style. Several reports, or views, could be created from Sales table 202 including, for example, volume in units by month and by style, and sales in dollars by month and by style. Although the different shoes styles might also be stored in a separate Style table that is not shown, its corresponding key field is shown in the Sales tables 202 and 207.

After a time, the footwear company in this example does well enough to sell footwear at several locations—Seattle and Los Angeles. Sales table 207 includes a location column. As above, the data in the location column would likely also be part of an Outlet table that would also include a key field and other characteristics about the locations such as addresses, etc.

Adding the location could involve additional reports being created on a per location basis.

Indeed, a variety of different reports could be generated from the sales table 207: For each style, by month and by location; for each month (or quarter or year) by location and by style, and so on. And as other criteria are added to the analyses performed by our illustrative footwear company—such as gender (e.g., men's, women's, boy's girl's), size, color, the size of the sales table grows as do the number of possible reports that can be created from it.

As tables are represented in two dimensions, it can be often difficult to view and analyze data in a convenient manner. In addition, in a traditional relational reporting system, analyses can often take significant time as multiple queries to the relational database are often necessary to get the desired information. OLAP can provide a solution to these problems by aggregating data from a relational database into cubes that provide context, relevance, and visualization of the data. As the data is aggregated into multidimensional views ahead of time, queries run fast and users can analyze data in an interactive manner.

FIG. 3 shows an illustrative OLAP cube 300 that provides a visualization of the quantity of products sold by the footwear company. Each cell of the cube shows a quantity of product sold by month, by location, and by style which are shown as labels on the axes of the cube 300. Thus, for example the 412 pairs of loafers sold in Seattle in October 2006 are shown by the numerical value “412” on the face of the cube 300. This numerical value is called a “measure.” The axes of the OLAP cube 300 are called “dimensions.” Seattle is an “attribute” of the location dimension. In this example, there are three dimensions used, but OLAP cubes may include more than three dimensions and are referred to as “hypercubes” in such cases. Thus, in an OLAP cube, dimensions define the structure of the cube, and measures provide the numerical values of interest to the user.

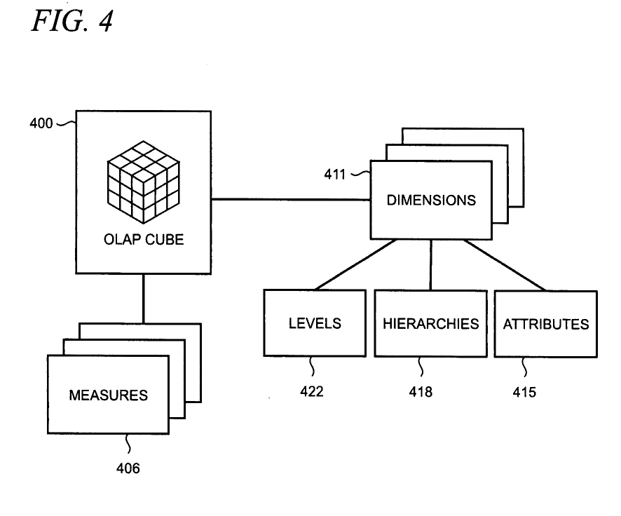

FIG. 4 shows the relationship among objects that form a generic OLAP cube 400. The measures 406 populate the cells of the OLAP cube with facts, typically those collected regarding operations of a business or enterprise. The measures are organized by dimensions 411, which typically include a time dimensions (i.e., where data is reported by some time period such as product sales volume by quarter).

Dimensions 411 are a fundamental component of OLAP cubes. They form the axes (i.e., edges) of the OLAP cube 400, and thus the measures within the cube. Dimensions organize data with relation to an area of interest, such as customers, stores, or employees, to users. OLAP cubes contain all the dimensions on which users base their analyses of fact data.

Dimensions 411 comprise a collection of related objects called attributes 415, which can be used to provide information about fact data. For example, typical attributes in a product dimension might include product names, product categories, product lines, product sizes, and product prices. Attributes 415 are bound to one or more columns in a table view of a relational database. These attributes appear as attribute hierarchies 418 and can be organized into user-defined hierarchies (that provide navigational, or drill-down paths to assist users when browsing an OLAP cube), or can be defined as parent-child hierarchies based on columns in an underlying data source. Hierarchies 418 are thus used to organize measures that are contained in an OLAP cube.

When attributes are arranged into user-defined hierarchies, relationships are defined between hierarchy levels 422 when levels are related in a many-to-one or a one-to-one relationship. For example, in a Calendar Time hierarchy, a Day level should be related to the Month level, the Month level related to the Quarter level, and so on. Defining relationships between levels 422 in a user-defined hierarchy enables the analysis services server 106 (FIG. 1) to define more useful aggregations to increase query performance and can also save memory during processing performance, which can be important with large or complex OLAP cubes.

A time dimension is a dimension type whose attributes represent time periods, such as years, semesters, quarters, months, and days. The periods in a time dimension provide time-based levels of granularity for analysis and reporting. Attributes that are described by time can often encompass a wide range—month, year, day, trimester, month of year, month of half year, flagged as a holiday, flagged as a workday, fiscal year . . . , and so on. The attributes are organized in hierarchies, and the granularity of the time dimension is determined largely by the business and reporting requirements for historical data. For example, many financial and sales data in business intelligence applications use a monthly or quarterly granularity.

Typically, the OLAP cubes 122 supported by the analysis services server 106 (FIG. 1) incorporate a time dimension in one form or another. An OLAP cube may include more than one time dimension, or several hierarchies from the same time dimension, depending on the granularity of the data and the reporting requirements. Not all OLAP cubes require a time dimension. Some OLAP applications, such as activity-based costing, do not require a time dimension because costing in an activity-based dimension based on activity instead of time. However, because the time type is used so frequently in OLAP, it presents a particularly significant dimension to which automated metadata deduction may be applied. Accordingly, the present arrangement is arranged to be well suited for deducing metadata associated with time in table columns, but it is emphasized that it not limited to time and may be used for deducing other types of metadata as well. For example, the present automated deduction arrangement is applicable to metadata associated with a geography type dimension (e.g., having attributes representing cities, states and regions), or with an account type dimension (having attributes that represent a chart of accounts for financial reporting).

Turning now to FIG. 5, details of metadata deduction engine 132 are presented. In this illustrative example, metadata deduction engine 132 includes a user interface application programming interface 506 (UI API), a deduction logic module 512, and deduction criteria 521. Metadata deduction engine 132 operates to analyze table columns and associated existing metadata 530 from a data source and produce new metadata tags 535 in an automated manner. Metadata deduction engine 132 analyzes tables to deduce time-related metadata in this example.

Metadata tags 535 enable OLAP cubes to be created by the analysis services server 106 having time dimensions that use the deduced time-related metadata. In particular, the metadata tags 535 are arranged to provide additional contextual meaning to the column data in a way the analysis services server 106 can understand. Thus, for example for a time dimension, January, February . . . etc., are abstracted into a metadata tag “Months of the Year,” while for a location dimension, Seattle, Los Angeles . . . etc. are abstracted into a metadata tag “Cities.” Of course, it will be appreciated that these are user-readable versions of the metadata tags which are typically embodied by mapping each tag to a unique numerical value or string for purposes of inter-process communication.

User interaction, as indicated by reference numeral 527, is also supported by the metadata deduction engine 132. In some applications of the present arrangement, user interaction 527 is optionally utilized. In this example, the user interaction includes a process by which the automated deduction is launched by a user, such as the administrator 128, and the deduced metadata is presented as suggestions to the user for confirmation using a GUI that is supported through the UI API 506. For example, the GUI may be arranged to enable the user to select a data source for analysis. In addition, the metadata that is deduced through the automated analysis may be presented to the user as suggestions which the user may verify as meeting the user's requirements for the particular OLAP cube being created.

The deduction logic module 512 provides the logic underlying the automated metadata deduction process to create metadata tags 535 using the table columns and existing metadata (i.e., table and column metadata) from the data source. Suggestions are also generated to support user interaction using the metadata tags 535.

Specifically, deduction logic module 512 applies one or more criteria from the deduction criteria 521 so as to make a determination of the likelihood that a particular metadata tag represents the data in column. In some applications, a fuzzy logic paradigm is utilized in which application of the one or more criteria produces a score that may be evaluated using, for example, a thresholding, weighting, expert system, or other deterministic, probabilistic, or statistical process. Therefore, the score can map to the likelihood that a particular column is represented by a particular metadata tag. It is noted that the order of the application of the one or more criteria does not generally matter.

FIG. 6 shows some illustrative criteria that are part of the set of deduction criteria 535. These operate as standards by which table columns are evaluated in order to perform the present automated deduction. The criteria include those that operate as a filter, and those that produce a score. The column data type criterion 606 is a filter type criterion that examines the metadata associated with a table column to determine its data type. This is typically one of text (i.e., string), numbers including integers and decimals, date, time, percentages, currency, etc. The identification of the data type enables some table columns to be filtered out as inappropriate candidates for containing time-related data. For example, a currency type means that a column is not likely to contain any days of the week.

The distinct count criterion 610 is also a filter type criterion. When applied, it evaluates (i.e., counts) the number of objects in a table column. For example, a distinct count of seven makes the column a candidate for containing the days of the week, where a count of twelve will filter that column out of contention as representing days of the week (although it would not be excluded for months of the year). If the count is greater than 366 (taking into account the extra day in leap years) then the column can be filtered out as a candidate for containing days of the year. A count greater than 31 eliminates the column as containing days of the month, and so forth.

The data values criterion 616 is another score type criteria that is applied to the data itself that is contained in a table column. For example, if application of the data type and distinct count criteria respectively determine that a column data type is text, and the distinct count is seven, then data values in the column can be checked for strings such as “M,” “Mon,” or “Monday” using the data values criterion 616.

It is recognized that there may be considerable variation in expressions for the day or week, where such variations take into account abbreviations, local customs or conventions, language, etc. Accordingly, rather than work as a binary pass/no pass filter, the application of the data values criterion 616 creates a score that takes into account the possibility of such variations. Thus for example, if “Monday” is found as a data value, then the score will reflect a greater likelihood that the column represents an attribute for days of the week. However, in the case that “Monday” or some other predictable variation is not found even though it is expected, rather than rule out the column out altogether, the score instead is adjusted to reflect less likelihood that the column represents the attribute for days of the week. The particular amount of adjustment that is made to the score through application of any of the score type criteria will generally be set according to the specific requirements of a particular application of the present arrangement for automated metadata deduction.

The column name criterion 622 works in the similar manner to provide a score that is associated with the likelihood that a table column represents a particular time attribute. In this case, the existing metadata associated with the column is evaluated to identify the name given to the column. If for example, the string “Day” or “Day of Week” or other some other predictable variation is identified, then a score is generated to indicate a reasonable likelihood that the column represents an attribute for days of the week. But as above, in order to take into account abbreviations, local customs and conventions, language and other factors, the column will not necessarily be ruled out as being a candidate for representing such an attribute. That is, score type criteria are arranged to reflect the recognition that is possible to miss what a user intended when labeling the column. For example, “Day” and “Day of Week” are reasonably predicable variations for the day of the week attribute, where expressions such as “D/Wk,” “D,” and “D-W” are more ambiguous.

The column relationship criterion 628 is also a score type criterion that evaluates the relationship among distinct counts in different table columns. This criterion makes use of the recognition that various types of time data follow a predictable schema. For example, a week has seven days, a year has 12 months, a year has 365 or 366 days, a month has 28, 29, 30 or 31 days, and so forth. Using this schema then, for example, if a column having a distinct count of 10 is believed to be likely as representing a years attribute, then column relationship criterion 628 may be used to compare it with another column in the table that is a candidate for representing a date attribute. If the distinct count for the suspected date column is approximately 3,650 (i.e., 365 days times the 10 years), then a score is generated to reflect that there is some likelihood that the suspected date column indeed contains dates. However, as there can be a variation in the number of days in a year, and some of the years in the column could be partial years (i.e., “stub” years in accounting), the comparison is not expected to yield a result that must match a precise value. Instead a range of expected values for the comparison may be used where greater deviation from the range results in a score adjustment that reflects less likelihood that the suspicion about the column that the column holds dates is accurate.

In general, the illustrative criteria 535 can be applied individually to a given table in a data source, or as a group, or in various combinations or two, three or four when making an automated deduction as to nature of the data contained in a particular table column. In cases where one than one criterion is applied, the results of their application may be weighted. In addition, the criteria may be implemented using a feedback system in which scoring and/or weighting may be adjusted in response to the verification of the suggested metadata tag by the user. If a user rejects a suggestion because it does not accurately capture the nature of the data contained in the column, then the method employed by one or more criterion can be varied to attempt to improve the accuracy. In some implementations, such variation will be based on a statistical analysis of a large amount of user feedback.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-readable storage medium containing instructions which, when executed by one or more processors disposed in an electronic device, implements a metadata deduction engine, comprising:
a deduction logic module arranged for performing logical analysis of a plurality of columns comprising a relational table, the logical analysis applying at least one deduction criterion to generate a logical abstraction of data objects in the columns, the logical abstraction being incorporated into a metadata tag that is usable for defining a dimension of an OLAP cube; and
a deduction criteria store arranged for holding at least one deduction criterion by which the data objects are analyzed using one of filtering criterion or scoring criterion.

2. The computer-readable storage medium of claim 1 in which the metadata deduction engine further includes a user interface API arranged to facilitate interaction with a user, the interaction including presenting a suggestion for the metadata tag to the user, and receiving feedback from the user to confirm the suggestion's accuracy.

3. The computer-readable storage medium of claim 1 in which the performing includes performing analysis of column metadata, the column metadata being selected from one of column data type or column name.

4. The computer-readable storage medium of claim 1 in which the dimension is a time dimension.

5. The computer-readable storage medium of claim 1 in which the dimension is a geography dimension.

6. The computer-readable storage medium of claim 1 in which the dimension is an account dimension.

7. The computer-readable storage medium of claim 1 in which the filtering criterion uses one of analysis of metadata indicative of column data type or a count of the data objects.

8. The computer-readable storage medium of claim 1 in which the scoring criterion uses one of analysis of metadata indicative of column name, analysis of column data values, or comparison of counts among columns.

9. The computer-readable storage medium of claim 1 in which the logic analysis uses one of fuzzy logic, deterministic process, statistical process, or probabilistic process.

10. A method of providing automated assistance to a user in creating an OLAP cube, the method comprising the steps of:
receiving an input from the user that is indicative of a selection of a data source from which the OLAP cube will utilize data;
applying one or more criteria to column data and associated metadata in a relational table in the data source to deduce metadata that is representative of data in the columns; and
generating a suggestion for a metadata tag that includes an abstraction of the column data.

11. The method of claim 10 including a further step of receiving an input from the user that is responsive to the suggestion.

12. The method of claim 11 in which the applying utilizes logic that is responsive to the input.

13. The method of claim 10 in which the criteria include scoring criteria and filtering criteria, the scoring criteria being selected from one of analysis of metadata for column name, analysis of column data values, or comparison of counts among columns, the filtering criteria using one of metadata indicative of column data type, or a count of the data objects.

14. A computer-implemented method for generating an abstraction of contextual meaning for a column of a relational table, the method comprising the steps of:
filtering metadata indicative of a data type of the column to include or exclude the abstraction as being representative of the column;
generating a first score for metadata indicative of the data name of the column, the first score mapping to a likelihood that the abstraction is representative of the column;
filtering a count of objects contained in the column to include or exclude the abstraction as being representative of the column;
generating a second score for one or more data values contained in the column, the second score mapping to a likelihood that the abstraction is representative of the column; and
generating a third score for a result of a comparison between respective counts of objects in columns of the relational table, the third score mapping to a likelihood that an abstraction is representative of the column.

15. The computer-implemented method of claim 14 in which the abstraction comprises a metadata tag.

16. The computer-implemented method of claim 15 in which the metadata tag is time-related.

17. The computer-implemented method of claim 15 including a further step of supplying the metadata tag to a process for creating an OLAP cube.

18. The computer-implemented method of claim 17 in which the creating comprises creating a dimension for the OLAP cube.

19. The computer-implemented method of claim 14 in which the steps of generating use one of fuzzy logic, deterministic process, statistical process, or probabilistic process.

20. The computer-implemented method of claim 14 in which the abstraction is a metadata tag.
